(19) United States
(12) Patent Application Publication
(10) Pub. No.: US 2024/0143505 A1
(43) Pub. Date: May 2, 2024

(54) METHODS TO SELECT THE DYNAMIC SUPER QUEUE SIZE FOR CPUS WITH HIGHER NUMBER OF CORES

(71) Applicant: Intel Corporation, Santa Clara, CA (US)

(72) Inventors: Amruta MISRA, Bangalore (IN); Ajay RAMJI, Austin, TX (US); Rajendrakumar CHINNAIYAN, Hillsboro, OR (US); Chris MACNAMARA, Limerick (IE); Karan PUTTANNAIAH, Beaverton, OR (US); Pushpendra KUMAR, Agra (IN); Vrinda KHIRWADKAR, Bengaluru (IN); Sanjeevkumar Shankrappa ROKHADE, Bengaluru (IN); John J. BROWNE, Limerick (IE); Francesc GUIM BERNAT, Barcelona (ES); Karthik KUMAR, Chandler, AZ (US); Farheena Tazeen SYEDA, Austin, TX (US)

(21) Appl. No.: 18/393,793

(22) Filed: Dec. 22, 2023

(51) Int. Cl. G06F 12/0811

(52) U.S. Cl. CPC G06F 12/0811

(57) ABSTRACT

Methods and apparatus for dynamic selection of super queue size for CPUs with higher number of cores. An apparatus includes a plurality of compute modules, each module including a plurality of processor cores with integrated first level (L1) caches and a shared second level (L2) cache, a plurality of Last Level Caches (LLCs) or LLC blocks and a plurality of memory interface blocks interconnect via a mesh interconnect. A compute module is configured to arbitrate access to the shared L2 cache and enqueue L2 cache misses in a super queue (XQ). The compute module further is configured to dynamically adjust the size of the XQ during runtime operations. The compute module tracks parameters comprising an L2 miss rate or count and LLC hit latency and adjusts the XQ size as a function of these parameters. A lookup table using the L2 miss rate/count and LLC hit latency may be implemented to dynamically select the XQ size.

### BACKGROUND INFORMATION

For several decades the performance of processors (also referred to a central processing units (CPUs) scaled roughly in accordance with Moore's law. This was achieved by a combination of smaller and smaller feature size (enabling more transistors on a CPU die) and increases in clock speed. Scaling performance using this approach has its physical limitations for both feature size and clock speed. Another way to continue to scale performance is to increase the number of processor cores. For example, substantially all microprocessors today that are used in desktop computers, laptops, notebooks, servers, mobile phones, and tablets are multi-core processors.

Recently, server products with very high core counts and platforms implementing the server products have been introduced. For example, Intel® Corporation's Sierra Forrest® Xeon® processors have 144 and 288 cores. These high core count CPUs and platforms serve the need of high throughput workloads such as Webserver, ad-ranking, social graph building, etc., very well. These workloads have a need of scaling out to many cores unlike the traditional workloads that scales up with more sophisticated and larger cores.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 is a diagram of a compute module, according to one embodiment;

FIG. 2 is a diagram of a cache hierarchy utilizing the computer modules of FIG. 1, according to one embodiment;

FIG. 3 is a schematic diagram of a computer system including an SoC processor having a plurality of tiles arranged in a two-dimensional array interconnected via mesh interconnect on-die fabric, according to one embodiment;

FIG. 4a is a schematic diagram of a computer system including a multi-die SoC or SoP including a compute die having an array of compute modules, LLC blocks, and memory interface blocks coupled to a pair of IO tiles, according to one embodiment;

FIG. 4b is a schematic diagram of a computer system including a multi-die SoC or SoP including a compute die having an array of compute modules with associated LLCs, and memory interface blocks coupled to a pair of IO tiles, according to one embodiment;

FIG. 5a is a diagram illustrating blown up details of a compute module and a mesh stop comprising a router, according to one embodiment;

FIG. 5ba is a diagram illustrating blown up details of a compute module with associated LLC and a mesh stop comprising a router, according to one embodiment;

FIG. 6 is a diagram illustrating further details of a compute module including an L2 arbiter, a super queue (XQ) and an XQ algorithm;

FIG. 7 is a diagram illustrating logic and inputs implemented by an XQ algorithm, according to one embodiment;

FIG. 8 is a graph showing a XQ size curve that is a function of L2 miss count/rate and L3 or LLC hit latency;

FIG. 9 is a lookup table used for determining the size of an XQ, according to one embodiment; and

FIG. 10 is a flowchart illustrating operations for determining an LLC hit latency using an LLC hit counter, according to one embodiment.

### DETAILED DESCRIPTION

Embodiments of methods and apparatus for dynamic selection of super queue size for CPUs with higher number of cores are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

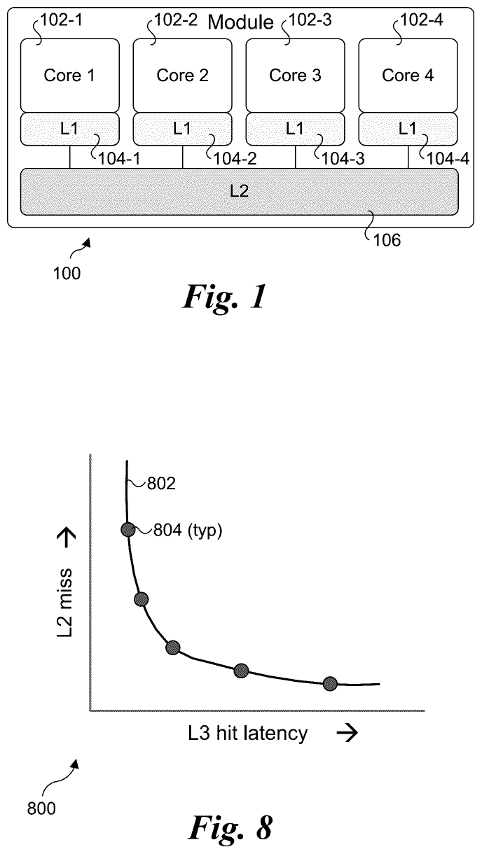

Under some embodiments a new core construct is introduced where multiple cores are clustered together and called a “core module” or simply “module.” For instance, FIG. 1 shows an embodiment of a module 100 including four cores 102-1, 102-2, 102-3, and 102-4. Each of the cores includes an integrated L1 (first level) cache, as depicted by L1 caches 104-1, 104-2, 104-3, and 104-4. The L1 caches may include separate L1 instruction and L1 data cases which are not separately shown in the Figures herein for simplicity. Module 100 further includes an L2 (second level) cache 106 that is shared amongst cores 102-1, 102-2, 102-3, and 102-4.

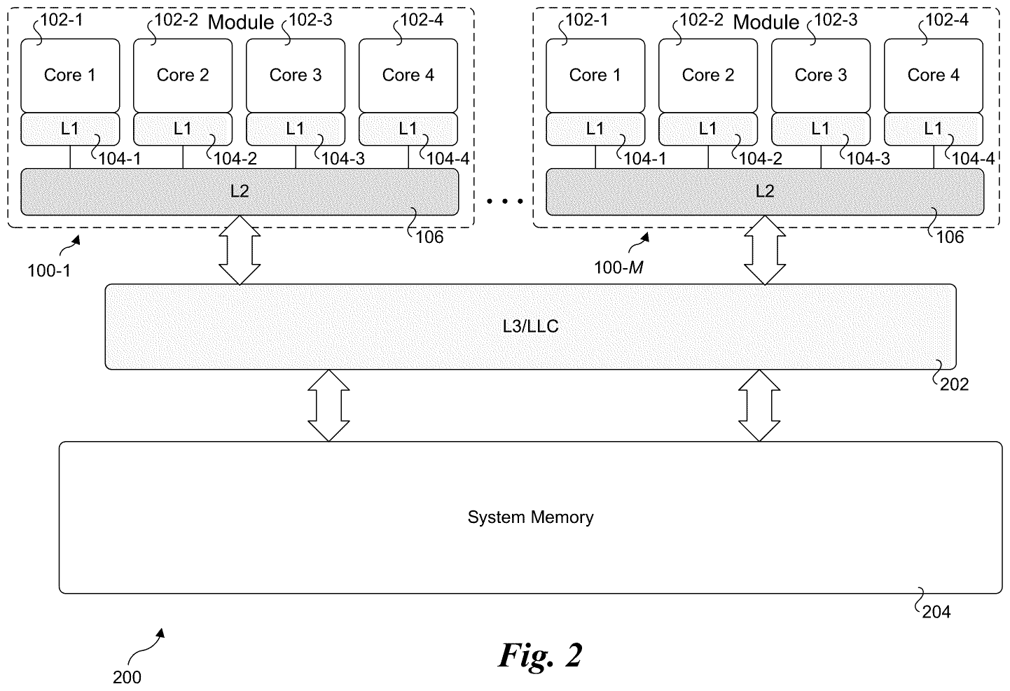

FIG. 2 shows an abstracted view of a cache hierarchy 200, according to one embodiment. The cache hierarchy includes M instances of module 100, and depicted by 100-1 . . . 100-M. The L2 caches 106 are connected to an L3/LLC cache 202, which in turn is connected to system memory 204. For simplicity, L3/LLC cache 202 is shown as a monolithic block; in practice, L3/LLC cache 202 is implemented using multiple IP (Intellectual Property) blocks or “tiles.”

Aspects of cache hierarchy 200 operations are conventional, such as use of cache coherency protocols and cache agents, with the particular protocols being outside the scope of this disclosure. In one embodiment, L3/LLC cache 202 is implemented as an inclusive cache where L3/LLC cache 202 maintains copies of cachelines that are currently in the L2 caches 106. As will be recognized by those skilled in the art, cache hierarchy 200 would include multiple cache agents to coordinate copying cachelines between cache levels, evicting cachelines, performing snoop operations, maintaining coherency, etc.

In a distributed processor architecture with a large number of cores (and modules) it may be advantageous to separate the L3/LLC cache blocks/tiles from the modules. It may also be advantageous to keep the L3/LLC cache blocks/tiles close to system memory. For example, cacheline writeback operations are frequently performed to sync modified cachelines in the L3/LLC with corresponding cachelines in system memory with correct data. For this and other reasons, the L3/LLC cache blocks/tiles are separated from the modules in the embodiments described and illustrated herein.

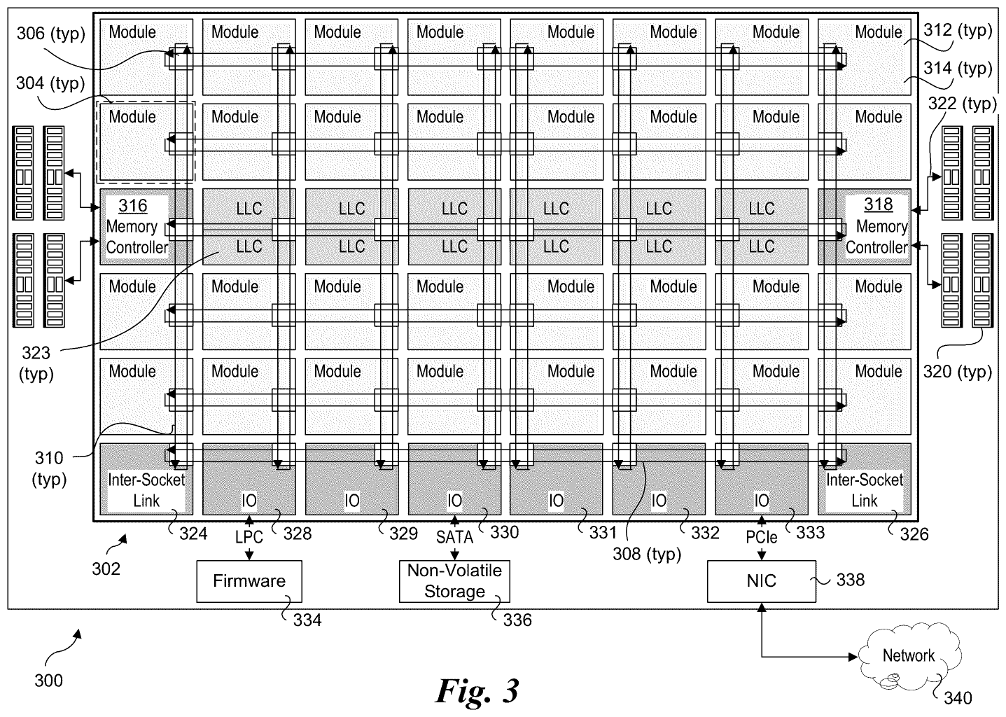

For example, FIG. 3 shows a server platform 300 that includes a System on a Chip (SoC) processor 302 with a plurality of “tiles” interconnect via a mesh fabric. SoC 302 includes 48 tiles 304 arranged in six rows and eight columns. Each tile 304 includes a respective mesh stop 306, with the mesh stops interconnected in each row by a ring interconnect 308 and in each column by a ring interconnect 310. Generally, ring interconnects 308 and 310 may be implemented as uni-directional rings (as shown) or bi-directional rings. Each ring interconnect 308 and 310 includes many wires (e.g., upwards of 1000) that are shown as single arrows for simplicity. The ring interconnects wiring is generally implemented in 3D space using multiple layers, and selected mesh stops support “turning” under which the direction of data, signals, and/or messages that are routed using the ring interconnects may change (e.g., from a horizontal direction to vertical direction and vice versa).

Processor SoC 302 includes 32 core modules 312, each implemented on a respective tile 304. Processor SoC 302 further includes a pair of memory controllers 316 and 318, each connected to one of more DIMMs (Dual In-line Memory Modules) 320 via one or more memory channels 322. Generally, DIMMs may be any current or future type of DIMM such as DDR4 (Double Data Rate version 4, initial specification published in September 2012 by JEDEC (Joint Electronic Device Engineering Council). LPDDR4 (Low-power DDR (LPDDR) version 4, JESD209-4, originally published by JEDEC in August 2014), WIO2 (Wide Input/Output version 2, JESD229-2 originally published by JEDEC in August 2014), HBM (High Bandwidth Memory, JESD325, originally published by JEDEC in October 2013), DDR5 (DDR version 5, JESD79-5A, published October, 2021), DDR version 6 (currently under draft development), LPDDR5, HBM2E, HBM3, and HBM-PIM, or others or combinations of memory technologies, and technologies based on derivatives or extensions of such specifications. The JEDEC standards are available at www.jedec.org.

Alternatively, or in addition to, Non-volatile memory may be used including NVDIMMs (Non-volatile DIMMs), such as but not limited to Intel® 3D-Xpoint® NVDIMMs, and memory employing NAND technologies, including multi-threshold level NAND flash memory (for example, Single-Level Cell (“SLC”), Multi-Level Cell (“MLC”), Tri-Level Cell (“TLC”), Quad-Level Cell (“QLC”), Penta-Level Cell (PLC) or some other NAND) and 3D NAND memory.

In the illustrated embodiment, memory controllers 316 and 318 are in a row including 12 Last Level Cache (LLC) tiles 323. Under an architecture employing the levels of cache, an LLC may also be called an L3 cache. The number of LLCs may vary by processor design. Under some architectures, each core is allocated a respective “slice” of an aggregated LLC (a single LLC that is shared amongst the cores). In other embodiments, allocation of the LLCs is more or less granular. In one embodiment, one or more L3/LLC slices may be implemented for an LLC tile.

Processor SoC 302 further includes a pair of inter-socket links 324 and 326, and six Input-Output (IQ) tiles 328, 329, 330, 331, 332, and 333. Generally, IO tiles are representative of various types of IO components that are implemented on SoCs, such as Peripheral Component Interconnect (PCIe) IO components, storage device IO controller (e.g., SATA, PCIe), high-speed interfaces such as DMI (Direct Media Interface), Low Pin-Count (LPC) interfaces, Serial Peripheral Interface (SPI), etc. Generally, a PCIe IO tile may include a PCIe root complex and one or more PCIe root ports. The IO tiles may also be configured to support an IO hierarchy (such as but not limited to PCIe), in some embodiments.

As further illustrated in FIG. 3, IO tile 328 is connected to a firmware storage device 334 via an LPC link, while IO tile 330 is connected to a non-volatile storage device 336 such as a Solid-State Drive (SSD), or a magnetic or optical disk via a SATA link Additionally, IO interface 333 is connected to a Network Interface Controller (NIC) 338 via a PCIe link, which provides an interface to an external network 340.

Inter-socket links 324 and 326 are used to provide high-speed serial interfaces with other SoC processors (not shown) when server platform 300 is a multi-socket platform. In one embodiment, inter-socket links 324 and 326 implement Universal Path Interconnect (UPI) interfaces and SoC processor 302 is connected to one or more other sockets via UPI socket-to-socket interconnects.

It will be understood by those having skill in the processor arts that the configuration of SoC processor 302 is simplified for illustrative purposes. A SoC processor may include additional components that are not illustrated, such as additional LLC tiles, as well as components relating to power management, and manageability, just to name a few. In addition, the use of 128 cores and 32 core modules (tiles) illustrated in the Figures herein is merely exemplary and non-limiting, as the principles and teachings herein may be applied to SoC processors with any number of cores.

Tiles are depicted herein for simplification and illustrative purposes. Generally, a tile is representative of a respective IP (intellectual property) block or a set of related IP blocks or SoC components. For example, a tile may represent a multi-core module, a memory controller, an IO component, etc. Each of the tiles may also have one or more agents associated with it (not shown).

Each tile includes an associated mesh stop node, also referred to as a mesh stop, which are similar to ring stop nodes for ring interconnects. Some embodiments may include mesh stops (not shown) that are not associated with any particular tile, and may be used to insert additional message slots onto a ring, which enables messages to be inserted at other mesh stops along the ring; these tiles are generally not associated with an IP block or the like (other than circuitry/logic to insert the message slots). FIG. 3 illustrates an example an SoC Processor showing tiles and their associated mesh stops.

It is noted that the interconnect architecture shown for SoC 302 is exemplary and non-limiting, as other types of interconnect architectures may be used.

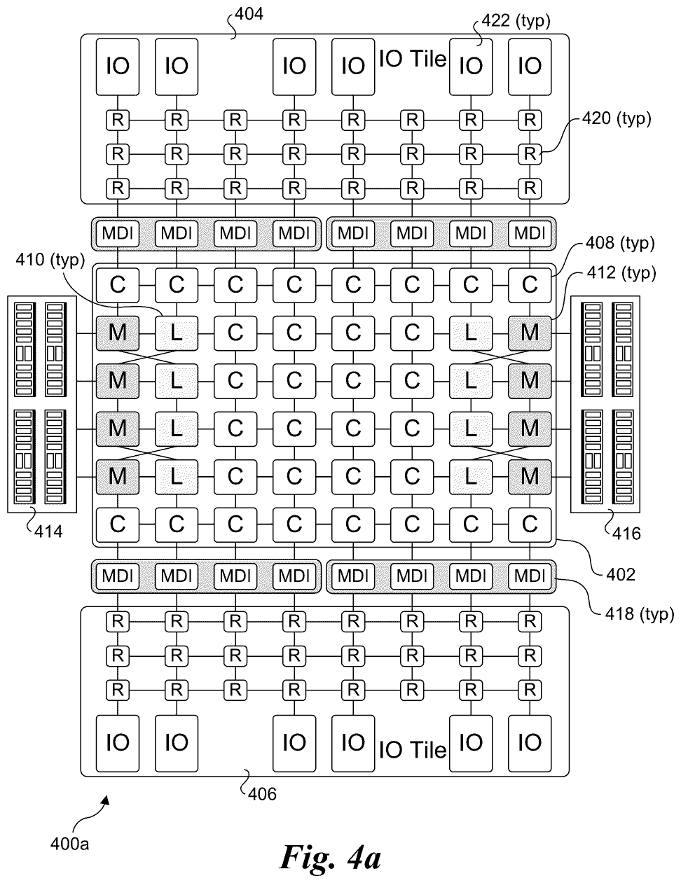

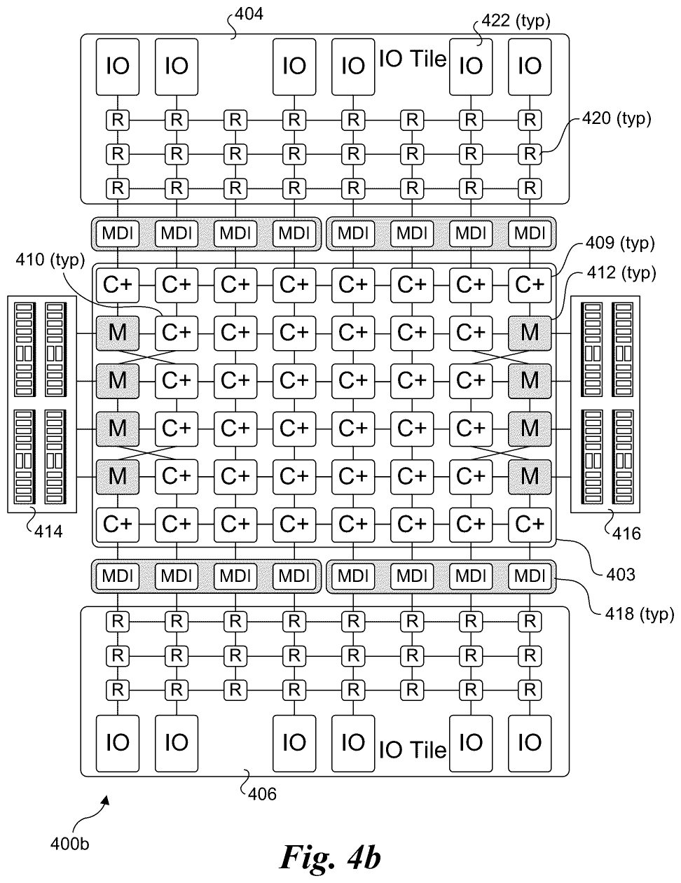

FIG. 4a shows a System on Package (SoP) 400a comprising multiple interconnected dies including a compute die 402 connected to an IO tile 404 and an IO tile 406. Compute die 402 includes a 2D array of IP block/tiles including 32 core modules 408 (labeled with a ‘C’), 8 LLC blocks 410 (labeled with an ‘L’) and 8 memory interface blocks 412 (labeled with an ‘M’). Memory interface blocks 412 are connected to memory 414 and memory 416, which may include one or more memory devices and collective comprise system memory. The core modules 408, LLC blocks 410 and memory interface blocks 412 are interconnected via a grid or mesh of interconnect links, which are depicted as single lines for simplicity. In one embodiment, an interconnect comprises an Intel® intra-die interconnect (IDI), which is a lightweight point to point interface. Other interconnect/interfaces may also be used.

The modules 408 in the top and bottom rows are respectively connected to interfaces (not shown) on IO tile 404 and IO tile 406, which comprise separate dies from compute die 402. In the illustrated embodiment the connections are implemented using multi-die interconnects (MDIs) 418. In one embodiment, MDIs 418 employ Intel's embedded multi-die interconnect bridge (EMIB) technology.

Each of IO tiles 404 and 406 include an array of routers 420 (labeled ‘R’) interconnected to each other via a mesh of interconnects and interconnected to IO blocks 422. IO blocks 422 are illustrative of various types of IO components, such as IO interfaces (e.g., PCIe, USB (Universal Serial Bus), UPI, etc.), on-die accelerators and/or accelerator interfaces to off-die accelerators (not shown), and other types of IO components.

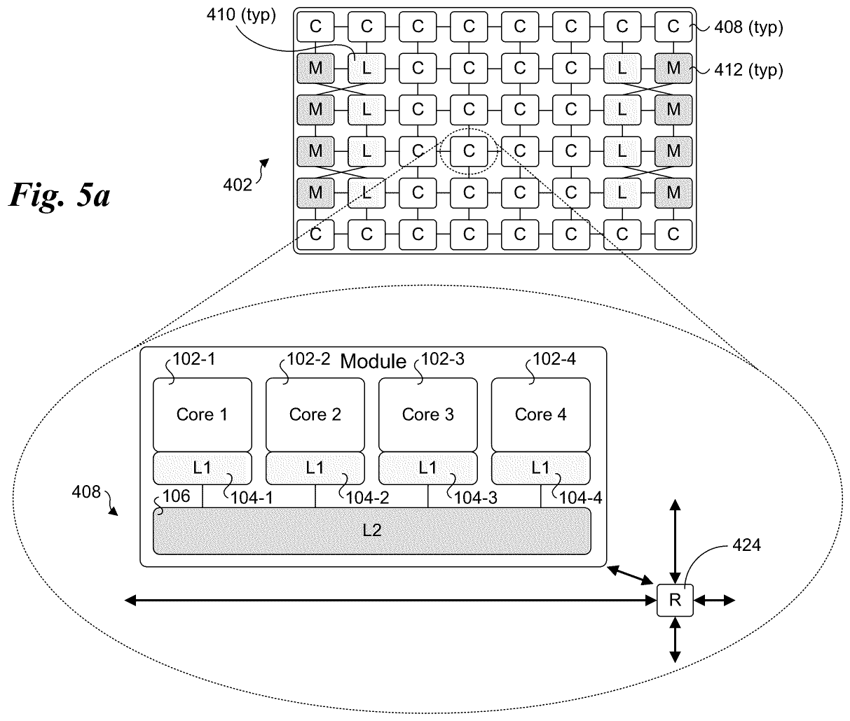

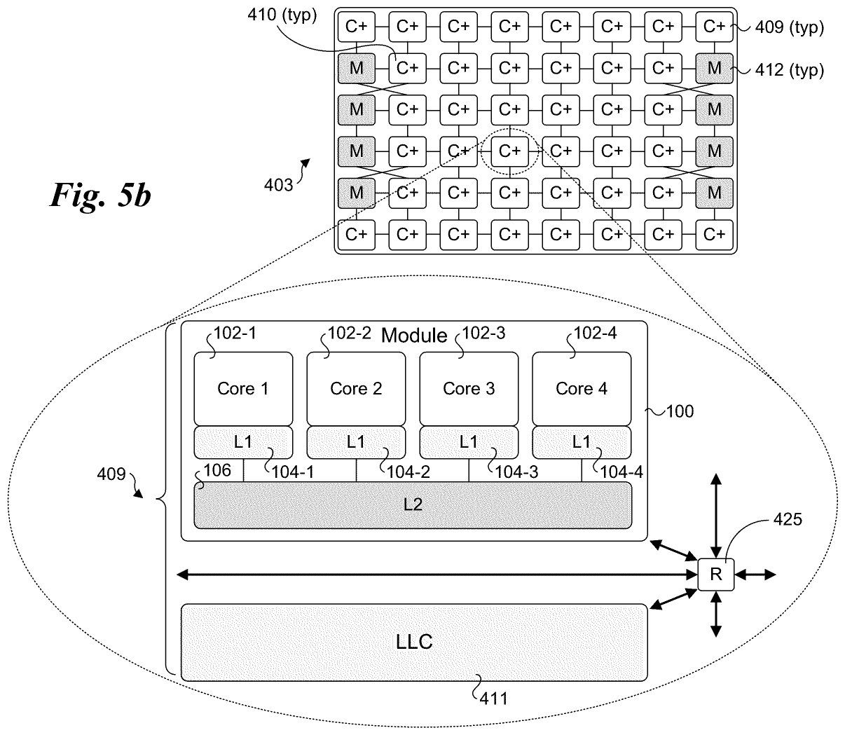

FIG. 5a shows further details of the interconnect mesh architecture, according to one embodiment. Each of modules 408 is connected to a respective mesh stop (node) 424 that is labeled with an ‘R’ in FIG. 5a to represent the routing functionality performed at each mesh stop. In a similar manner, each of LLC blocks 410 and memory interface blocks 412 is connected to a respective mesh stop.

Since the mesh stops handle bi-directional traffic from multiple directions and sources (e.g., North-South, East-West and ingress/egress module traffic), each provides an associated set of ingress and egress ports with associated buffers for each direction along with circuitry/logic for arbitrating the traffic passing through it. In some embodiments, a credit-based forwarding scheme is used employing multiple message classes having different priority levels. Other known router arbitration schemes and interconnect fabric protocols may be used, wherein the particular router arbitration scheme and interconnect fabric protocol is outside the scope of this disclosure.

Under a conventional mesh interconnect architecture with single cores, each mesh stop will have one or more egress buffers for outbound module traffic having (a) predetermined size(s). Under the SoC and SoP architectures disclosed herein, there are additional buffering considerations based in part on having a shared L2 cache and for module access to the mesh fabric where the distance to a nearest or associated LLC may vary. For example, using a shared L2 cache amongst four cores could nominally lead to an increase of L2 misses by a factor of 4—each L2 miss would require access to the LLC associated with the module. Moreover, the level of buffering (buffer size) may vary by module based on physical location in the compute die and/or dynamic workload considerations.

For example, compare the location of modules 408 in the two center columns (4 and 5) relative to the location of a nearest LLC block 410 to the location of modules 408 in columns 2 and 6 and the four corners relative to the location of a nearest LLC block 410. The number of interconnect link segments, aka “hops,” is significantly greater for modules 408 in columns 4 and 5. Also consider that there is multi-way traffic that is handled at each mesh stop, meaning traffic being forwarded in a given direction (such as along a shortest path) may be stalled for one or more mesh stop cycles at each mesh stop. This creates performance issues since the latency for forwarding traffic (messages, data, etc.) between different modules and their nearest or associated LLC block vary. This issue is more prominent when all cores per module are active vs lesser cores per module (1 core per module/2 core per module/3 core per module) is/are active.

FIG. 4b shows an SoP 400b comprising a variant of SoP 400a having a compute die 403 connected to an IO tile 404 and an IO tile 406 via MDIs 418. Compute die 403 differs from compute die 402 in that the core modules have associated LLCs that are co-located and do not include separate LLC blocks 410. As shown, compute die 403 includes a 2D array of IP block/tiles including 40 core modules 409 with co-located LLCs (labeled with a ‘C+’) and 8 memory interface blocks 412 (labeled with an ‘M’).

FIG. 5b shows further details of a core module 409, which includes a core module 100 as shown in FIG. 1 and described above, and an LLC 411 coupled to a mesh stop (node) 425 labeled with an ‘R’ to represent the routing functionality performed at each mesh stop to which a core module 409 is coupled. As further shown, mesh stop 425 provides a 6-way routing function (East, West, North, South, plus ingress and egress paths for each of core module 100 and LLC 411.

While core module 100 and LLC 411 have the same physical distance for each core module 409, that does not mean the LLC hit latency for each core module 409 stays the same during runtime operations and different workloads. This is due, in part, to each mesh stop 425 having to forward traffic originating from and/or destined other IP blocks in four directions in addition to providing ingress and egress access to each of core module 100 and LLC 411. For example, consider that an LLC miss on a memory read will result a corresponding memory read access request message being forwarded to a memory interface block 412. The memory interface block will issue a memory read for the requested cacheline address and will generate a corresponding memory read access response message containing a copy of the request cacheline (noting that in some embodiments multiple cachelines may be requested and returned in single messages). The result of this is that mesh stops associated with the core modules toward the middle of compute die 403 may see more traffic than core modules along the periphery of compute die 403 (e.g., the core modules 409 in the first and sixth rows). Additionally, the LLC hit latency may vary for other reasons, such as how different types of workloads are distributed amongst core modules 409, whether all or less than all cores in a core module are being utilized, etc.

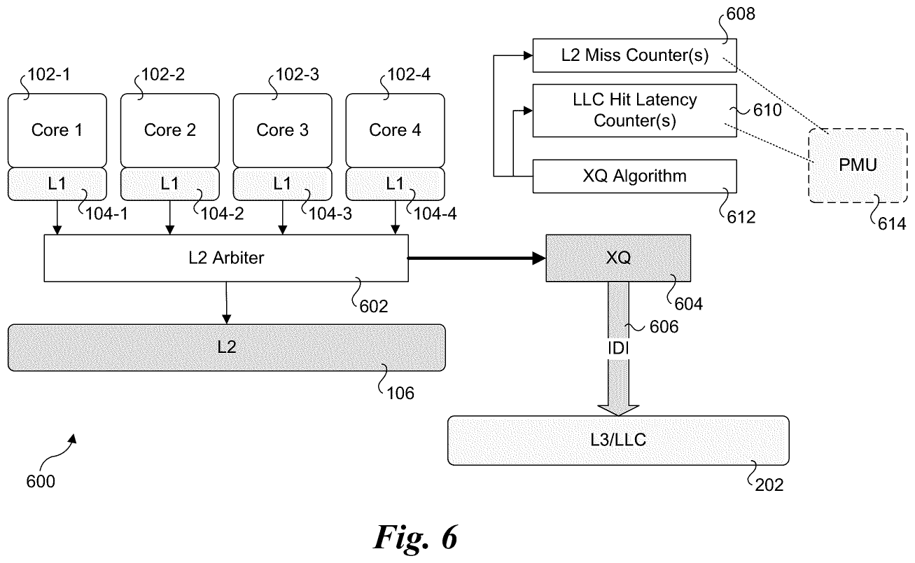

FIG. 6 shows a module architecture 600 for addressing different LLC hit latency issues, according to one embodiment. Access to L2 cache 106 for each of L1 caches 104-1, 104-2, 104-3, and 104-4 is controlled by an L2 arbiter 602. In addition, for a L2 cache miss, L2 arbiter 602 will forward an applicable memory access request (such as a memory read or write request) to L3/LLC cache 202 (which is representative of a nearest LLC block or an LLC block that is associated with a given module or a co-located LLC). This forwarding path includes a super queue (XQ) 604 located on the module or co-located with a mesh stop), and an IDF path 606, which is representative of a forwarding path of one or more hops using IDI links.

Module architecture 600 further includes one or more L2 miss counters 608 and one or more LLC hit latency counters 610, and circuitry/logic for implementing an XQ algorithm 612. The L2 miss counters maintain a count of L2 misses and can be periodically reset to 0. The L2 miss counters may include a current (instantaneous) count and a last count over the reset period. Accordingly, XQ algorithm 612 can read the last count value to determine a (substantially) current L2 miss rate. LLC hit latency counter(s) 610 are used to track the latency of LLC hit accesses (that is, when a snoop of the applicable LLC results in a hit, meaning a valid copy of the snooped cacheline is present in the LLC). Generally, L2 misses and/or LLC hit latency may be tracked on a per-core or per-module basis. In one embodiment L2 miss counters 608 and LLC hit latency counters 610 comprise perfmon (performance monitor) counters and/or may be implemented in an optional performance monitoring unit (PMU) 614.

Since four of the cores from same module are using the same XQ, an XQ having a larger size is advantageous when there are a significant number of L2 misses. The larger XQ can hold more L2 misses before sending them to LLC. At the same time, larger size of XQ increases the time to access an applicable LLC for a given memory request from a given module.

To address performance issues, the XQ algorithm is employed to configure the XQ size dynamically as a function of the L2 miss rate and the L3 hit latency. In one aspect, the XQ algorithm uses a balanced scheme to dynamically adjust the size of the XQ using runtime performance metrics (e.g., using L2 miss counter values and LLC hit latency values).

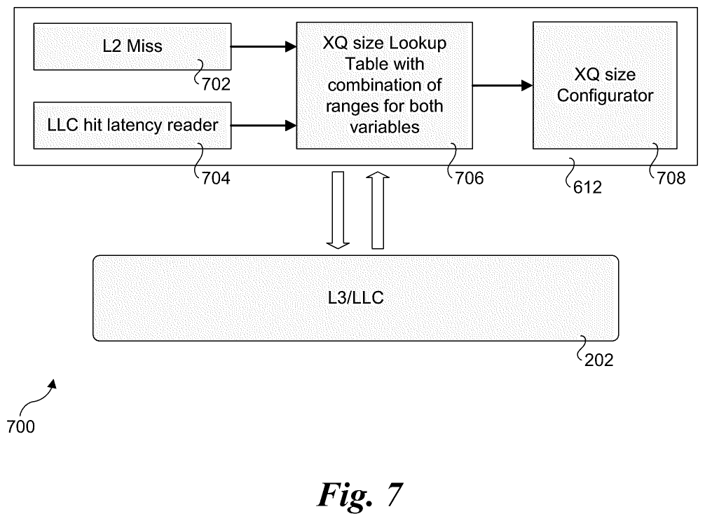

Diagram 700 of FIG. 7 graphically illustrates the XQ algorithm, according to one embodiment. The XQ algorithm takes two inputs from L2 miss counters 608 and LLC hit latency counters 610: 1) number of L2 misses; and 2) L3 hit latency.

In one embodiment, the XQ algorithm creates a lookup table derived from these two parameters and their ranges to define what the size of the XQ should be. Preferably, the size of the XQ should be decided on high L2 misses vs. low L3 hit latency. These two parameters might not have a real dependency on each other.

As shown in diagram 700, the inputs are an L2 Miss 702 and an LLC hit latency reader 704. L2 miss 702 is a count of L2 misses for a given module for a given time period (or otherwise a rate of misses per unit time), which is tracked using L2 miss counters 608. LLC hit latency reader 704 reads LLC hit latency values from LLC hit latency counters 610. More generally, LLC hit latency counters may be implemented using counters used for backend stall metrics and the like.

As shown in a block 706, an XQ size lookup table is created/maintained with a combination of ranges for both the input variables. An XQ size configurator utilizes the XQ size lookup table to dynamically adjust the XQ size by selecting the best match from the XQ size lookup table.

In one embodiment, the XQ algorithm applies weighting to a range for each parameter. For example,
L2 Miss of range n to n+10000→N
L3/LLC hit latency of t to 1000t→T
   where n and t are predetermined integers. The size of XQ is calculated as N*T, which is a function of both input parameters. When calculating the size based on N*T a lookup table is not utilized.

The ranges of the two input parameters are shown in TABLE 1 below:

TABLE 1

| Parameter | Range | Size of XQ |
|---|---|---|
| L2 Miss | n to n + 1000 | Sxq1 |
| L3 hit latency | t to 1000t | |

FIG. 8 shows a graph 800 illustrating a curve 802 derived from input samples 804 of N*T.

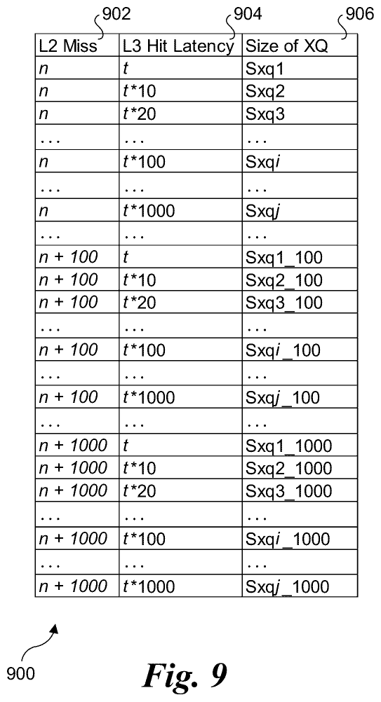

In addition to linear functions such as N*T, an XQ algorithm may employ a non-linear function to determine/calculate the size of XQ. In one embodiment the non-linear function may be digitally modeled via row-column data in an XQ size lookup table. FIG. 9 shows an XQ size lookup table 900 having example entries corresponding to the ranges in TABLE 1 above. Lookup table 900 includes an L2 miss column 902, an L3 hit latency column 904, and a size of XQ column 906. L2 miss and L3 hit latency values are used as the lookup values, with a lookup returning a size of XQ value. For simplicity and point of illustration, lookup table 900 only shows a small fraction of the rows that would be present in an actual implementation. The arrangement of the values in L2 miss column 902 and L3 hit latency column 904 is exemplary and non-limiting. The granularity of the values for L2 misses and L3 hit latency may also vary to meet performance needs and/or to address available on-module memory resources.

In other embodiments, the XQ algorithm may consider other inputs, such as performance metrics that indicate backend bound, front end and backend stall metrics, and other metrics generated by the module (e.g., generated by cores on the module and/or by circuitry/logic on the module such as a PMU or the like). For example, a non-limiting list of XQ algorithm inputs (in addition to or in place of L2 miss rate/count and/or LLC latency) may include one or more metrics relating to frontend bound (e.g., frontend latency, frontend bandwidth), bad speculation (e.g., branch misprediction, machine clears), backend bound (e.g., backend stall indicator metrics, memory bound, core bound), number of active cores, core threads, core activity level, and module location within the grid (e.g., proximity to memory controllers/interfaces, proximity to IO (for modules/core coupled to routers handling a lot of IO traffic)). It is also possible that different modules will implement XQ size lookup tables with different values, such as based on location of module within the grid, number of active cores, core activity level(s), etc. The XQ algorithm may also be configured to perform an XQ size lookup table based on L2 miss rate/count and LLC latency and adjust the returned XQ size value based on one or more other metrics. As before, the XQ algorithm may implement either linear functions or non-linear functions.

The XQ also may be tuned based on heuristics or the like. For example, the XQ algorithm may adjust the weights of one or more inputs and observe the behavior of the XQ fill level and/or LLC latency and/or observe other performance metrics. In some embodiments, a module may include registers in which weights are stored where the weights may be modified by software running on the platform and the XQ algorithm reads the weights (rather than the algorithm itself adjusting the weights). In this manner, the platform running on the platform is used to tune the XQ algorithm. These approaches may be used, for example, to tune the XQ algorithm for modules handling a particular type of workload where a given module (or set of modules) is tasked with executing software to perform that workload.

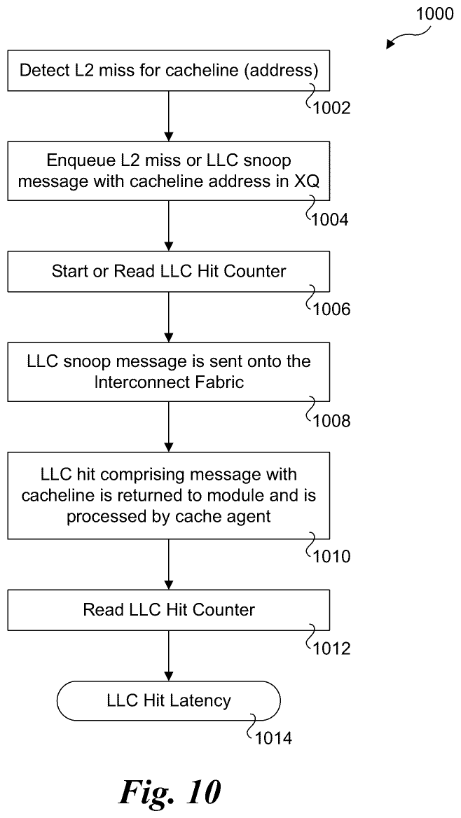

FIG. 10 shows a flowchart illustrating operations for determining an LLC hit latency using an LLC hit counter, according to one embodiment. The flow begins in a block 1002 in which an L2 miss for a cacheline is detected. In response, in a block 1004 the L2 miss or an LLC snoop message with the cacheline address is enqueued in the XQ. An LLC hit counter is started in a block 1006. Optionally, for an ongoing counter, a current count of an LCC hit counter is read. In some embodiments an L2 miss is enqueued in the XQ and subsequently converted to a corresponding LLC snoop message before being enqueued in an ingress buffer associated with the mesh stop to which the compute module is coupled.

In a block 1008, the LLC snoop message is sent onto the interconnect fabric. In a block 1010 an LLC hit comprising a message with the cacheline is returned to the module and is processed by a cache agent or the like on the module. For example, in one embodiment the cache agent writes the cacheline in the L2 cache and/or writes the cacheline to an applicable L1 cache.

In a block 1012 the LLC hit counter is read. If the LLC hit counter was reset in block 1006, the count value of the LLC hit counter is the LLC hit latency and this value is returned as the LLC hit latency in an end block 1014. If an ongoing counter was read from an LLC hit counter in a block 1006 the current value of the counter is read in block 1012 and the count read in block 1006 is subtracted with the difference being returned as the LLC hit latency in block 1014.

In one embodiment, one or more secondary parameters may be considered that influence the value of these primary parameters, such as core frequency, size of L2 cache, size of L3/LLC, number of mesh stops, etc. Additionally, different modules may use different criteria for determining the size of the XQ associated with those modules.

Experimental results have demonstrated improved performance using the XQ algorithm and associated architecture disclosed herein. For example, under one set of tests reducing the XQ size to half demonstrated a performance improvement of 20%. However, reducing the XQ size more resulted in more L3 misses and impacted the performance. Accordingly, the size of XQ should be a balance of how many L2 missed the XQ can hold vs. the increase in L3 cache latency as the size of XQ increases.

While various embodiments described herein use the term System-on-a-Chip or System-on-Chip (“SoC”) to describe a device or system having a processor and associated circuitry (e.g., IO circuitry, power delivery circuitry, memory circuitry, etc.) integrated monolithically into a single Integrated Circuit (“IC”) die, or chip, the present disclosure is not limited in that respect. For example, in various embodiments of the present disclosure, a device or system can have one or more processors (e.g., one or more processor cores) and associated circuitry (e.g., IO circuitry, power delivery circuitry, etc.) arranged in a disaggregated collection of discrete dies, tiles and/or chiplets (e.g., one or more discrete processor core die arranged adjacent to one or more other die such as memory die, IO die, etc.). In such disaggregated devices and systems the various dies, tiles and/or chiplets can be physically and electrically coupled together by a package structure including, for example, various packaging substrates, interposers, active interposers, photonic interposers, interconnect bridges and the like. The disaggregated collection of discrete dies, tiles, and/or chiplets can also be part of a System-on-Package (“SoP”).

In the preceding description and Figures, the term “super queue” is used to distinguish the queue that is associated with a module or co-located with a mesh stop from other queues and buffers in a system. This is for convenience and for illustrative purposes, as the “super queue” is, generally, a queue or similar structure that is associated with a module and/or co-located with a mesh stop (to which the module is coupled) and in which L2 misses or L3/LLC snoop messages are stored.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other. Additionally, “communicatively coupled” means that two or more elements that may or may not be in direct contact with each other, are enabled to communicate with each other. For example, if component A is connected to component B, which in turn is connected to component C, component A may be communicatively coupled to component C using component B as an intermediary component.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

An algorithm is here, and generally, considered to be a self-consistent sequence of acts or operations leading to a desired result. These include physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Italicized letters, such as ‘i’, ‘j’, ‘M’, ‘n’, ‘t’, etc. in the foregoing detailed description are used to depict an integer number, and the use of a particular letter is not limited to particular embodiments. Moreover, the same letter may be used in separate claims to represent separate integer numbers, or different letters may be used. In addition, use of a particular letter in the detailed description may or may not match the letter used in a claim that pertains to the same subject matter in the detailed description.

As used herein, a list of items joined by the term “at least one of” can mean any combination of the listed terms. For example, the phrase “at least one of A, B or C” can mean A; B; C; A and B; A and C; B and C; or A, B and C.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

What is claimed is:

1. An apparatus, comprising:
a mesh interconnect including a plurality of mesh stops;
a plurality of Last Level Caches (LLC) or LLC blocks coupled to respective mesh stops; and
a plurality of memory interface blocks coupled to respective mesh stops; and
a plurality of compute modules coupled to respective mesh stops, each compute module having a plurality of processor cores with associated first level (L1) caches and a shared second level (L2) cache and configured to enqueue L2 misses in a queue associated with the compute module and dynamically adjust a size of the queue.

2. The apparatus of claim 1, wherein an LLC is co-located with a compute module under which the LLC and compute module are coupled to a same mesh stop.

3. The apparatus of claim 1, wherein dynamically changing the size of the queue uses input parameters including at least one of:
L2 miss rate or count; and
an LLC hit latency.

4. The apparatus of claim 3, wherein a compute module maintains one or more backend stall metrics counters and includes circuitry for determining an LLC hit latency that utilizes the one or more backend stall metrics counters.

5. The apparatus of claim 3, wherein a compute module is configured to maintain a queue size lookup table that employs lookup parameters comprising the L2 miss rate or count and the LLC hit latency and returns a queue size.

6. The apparatus of claim 1, wherein a compute module further comprises an L2 arbitrator that is configured to arbitrate access to the shared L2 cache from amongst the plurality of processor cores and to queue an LLC snoop message associated with an L2 miss in the queue.

7. The apparatus of claim 1, wherein the apparatus comprises a die comprising the plurality of compute modules, the plurality of LLC blocks, the plurality of memory interface blocks, and the mesh interconnect, the die further comprising a plurality of input-output (IO) blocks coupled to mesh stops in the mesh interconnect.

8. The apparatus of claim 1, wherein the apparatus comprises a compute die or tile comprising the plurality of compute modules, the plurality of LLC blocks, the plurality of memory interface blocks, and the mesh interconnect, further comprising:
one or more input-out (IO) tiles, each comprising a die including a plurality of IO blocks interconnected via a mesh interconnect; and
for each IO tile, one or more multi-die interconnects coupled between the compute die and the IO tile.

9. A method implemented on an apparatus having a mesh interconnect including a plurality of mesh stop nodes to which a plurality of compute modules having a plurality of processor cores with integrated first level (L1) caches and a shared second level (L2) cache, a plurality of Last Level Caches (LLCs) or LLC blocks, and a plurality of memory interface blocks are coupled, the method comprising:
for a compute module,
detecting L2 misses;
enqueuing L2 misses or LLC snoop messages associated with L2 misses in a queue associated with the compute module; and
dynamically adjusting a size of the queue during run-time operations of the apparatus.

10. The method of claim 9, further comprising:
for a compute module,
determining at least one of,
an L2 cache miss rate or count; and
an LLC hit latency; and
adjusting the size of the XQ based at least in part on at least one of the L2 cache miss rate or count and the LLC hit latency.

11. The method of claim 10, further comprising implementing a lookup table employing a lookup comprising an L2 cache miss rate or count and an LLC hit latency value or count and returning a size of the queue.

12. The method of claim 10, further comprising:
for a compute module,
implementing one or more L2 miss counters; and
employing at least one of the one or more L2 miss counters to determine an L2 miss rate or count.

13. The method of claim 9, further comprising, for a compute module, implementing an L2 arbiter to arbitrate access to the shared L2 cache for the compute module.

14. The method of claim 13, further comprising:
detecting an L2 cache miss associated with a cacheline;
generating an LLC snoop message corresponding to the cacheline; and
enqueuing the LLC snoop message in the queue for the compute module.

15. The method of claim 14, further comprising
resetting a counter when the LLC snoop message is enqueued in the queue;
processing, at the compute module, an LLC hit message returned in response to the LLC snoop message; and
determining an LLC hit latency based on a count of the counter when the LLC hit message is processed.

16. A system, comprising:
a mesh interconnect, comprising a plurality of interconnected mesh stops;
a plurality of compute modules coupled to respective mesh stops, each compute module having a plurality of processor cores with integrated first level (L1) caches and a shared second level (L2) cache, and configured to enqueue L2 misses in a queue associated with the compute module and dynamically adjust a size of the queue;
a plurality of Last Level Caches (LLCs) or LLC blocks coupled to respective mesh stops; and
a plurality of memory interface blocks coupled to respective mesh stops; and
a plurality of memory devices, each memory device coupled to one or more memory interface block.

17. The system of claim 16, wherein a compute module further comprises an L2 arbitrator that is configured to arbitrate access to the shared L2 cache from amongst the plurality of processor cores and to queue an LLC snoop message associated with an L2 miss in the queue.

18. The system of claim 16, wherein the size of a queue is determined based on parameters including at least one of:
an L2 miss rate or count; and
an LLC hit latency.

19. The system of claim 16, wherein the system includes a die comprising the plurality of compute modules, the plurality of LLCs or LLC blocks, the plurality of memory interface blocks, and the mesh interconnect, the die further comprising a plurality of input-output (IO) blocks coupled to mesh stops in the mesh interconnect.

20. The system of claim 16, wherein the system includes a compute die or tile comprising the plurality of compute modules, the plurality of LLCs or LLC blocks, the plurality of memory interface blocks, and the mesh interconnect, further comprising:
one or more input-out (IO) tiles, each comprising a die including a plurality of IO blocks interconnected via a mesh interconnect; and
for each IO tile, one or more multi-die interconnects coupled between the compute die and the IO tile.
